(19) United States
(12) Patent Application Publication
(10) Pub. No.: US 2005/0115817 A1
(43) Pub. Date: Jun. 2, 2005

(54) Push button switch

(76) Inventor: Ocean H.R. Zhou, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/998,883

(22) Filed: Nov. 29, 2004

(30) Foreign Application Priority Data
Dec. 2, 2003 (TW) 92133869

(51) Int. Cl. H01H 1/24

(52) U.S. Cl. 200/532

(57) ABSTRACT

A push button switch (1) includes an insulative housing (2), a cover (3), an actuator (4), a common contacting contact (5), a non-common contacting contact (6) and a movable contact (7). The cover engages with the housing and defines a guiding hole (311). The movable contact is received in the housing and includes a connecting portion (77), a supporting portion (76), and a pressable section (74) connecting the supporting portion. A non-common contacting contact is mounted in the housing and has a non-common contacting strip (63). A common contacting contact is mounted in the housing, includes a common contacting strip (53), engages with the connecting portion of the movable contact and is movable with the movable contact to touch the non-common contacting strip, thereby electrically connecting with the non-common contacting contact.

### BACKGROUND OF THE INVENTION

1. Field of the Invention

The present invention relates to a push button switch in which a plurality of separate contacts may be electrically connected together via a manual depression on the push button.

2. Description of the Prior Art

The push button switches are widely used in many applications such as home electric applications, business machines, and communication devices.

One conventional push button switch is disclosed in JP. Pat. No. 11-144560. The push button switch comprises a housing, a first contact, a second contact, a movable contact and an actuator. The housing has a substantially cubic configuration. The second contact separates with the first contact and is mounted with a planar base plate. The movable contact made of flexible conductive material is in a substantially U-shaped configuration. The movable contact has a contacting portion defined at one end of an arm and a positioning portion at one end of the other arm. The contacting portion slides to contact with the first contact. The positioning portion engages with the second contact and is capable of pivoting therearound. The actuator is substantially a rod and can be pressed downwardly to actuate the movable contact.

In operation, the actuator is pressed downwardly and the movable contact pivots around the positioning portion, which in turn causes the contacting portion to slide to contact with the first contact. Thus the first contact and the second contact are electrically connected, the switch is on.

Though the switch works well, there are some problems it cannot solve. The conventional switch needs lube between the contacting portion and the housing, thereby ensuring a smooth movement of the contacting portion during contacting/discontacting with the first contact. Furthermore, the first contact is mounted on the bottom wall of the housing and has a planar configuration. So the dust is easy to be gathered on the first contact. This structure may result in an unreliable electrical connection. So an improvement is in need.

### BRIEF SUMMARY OF THE INVENTION

In according with the conventional invention, a main object of this invention is to provide a switch which is capable of establishing a convenient and reliable electrical connection. On the basis of this solution, a push button switch is available in which the structure of the movable contact is improved.

A push button switch having a reliable electrical connection comprises a housing, a cover, an actuator, a pair of fixed contacts and a movable contact. The housing has a base. A periphery wall extends from the base and a cavity is defined therein. The movable contact made of flexible conductive material is received in the housing and comprises a periphery section, and a pressable section. The pair of fixed contacts mounted in the housing comprises a common contacting contact and a non-common contacting contact. The non-common contacting contact has a non-common contacting strip projecting substantially parallel to the actuating direction. The common contacting contact engages with the periphery section of the movable contact and is able to be brought to surface contact with the non-common contacting contact strip in operation. The actuator actuates on the pressable section of the movable contact.

The switch further comprises a cover engaging with the housing and the cover defines a guiding hole. The actuator comprises an operating portion extending beyond the guiding hole. The common contacting contact has a common contacting strip and forms a hook portion at an upper end of the common contacting strip. The hook portion engages with the periphery section of the movable contact.

In the present invention, the common contacting strip is capable of being moved with the movable contact to touch the non-common contacting strip, thereby establishing electrical connection with the non-common contacting strip. As a result, the switch avoids a sliding operation. Thus, it's no need for the switch to use lube and this structure can also prevent the dust to be gathered on the contacts.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a switch according to this invention;

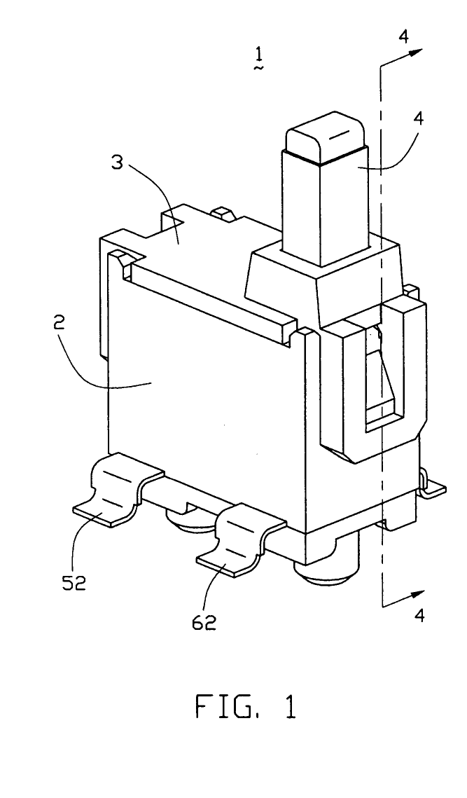

FIG. 2 is an exploded view of FIG. 1;

FIG. 3 is another exploded view of FIG. 1;

FIG. 4 is a cross-sectional view taken from line 4-4 of FIG. 1 wherein the switch is in a normal status; and

FIG. 5 is a cross-sectional view taken from line 4-4 of FIG. 1 but with the switch being depressed.

### DETAILED DESCRIPTION OF PREFERRED EMBODYMENTS

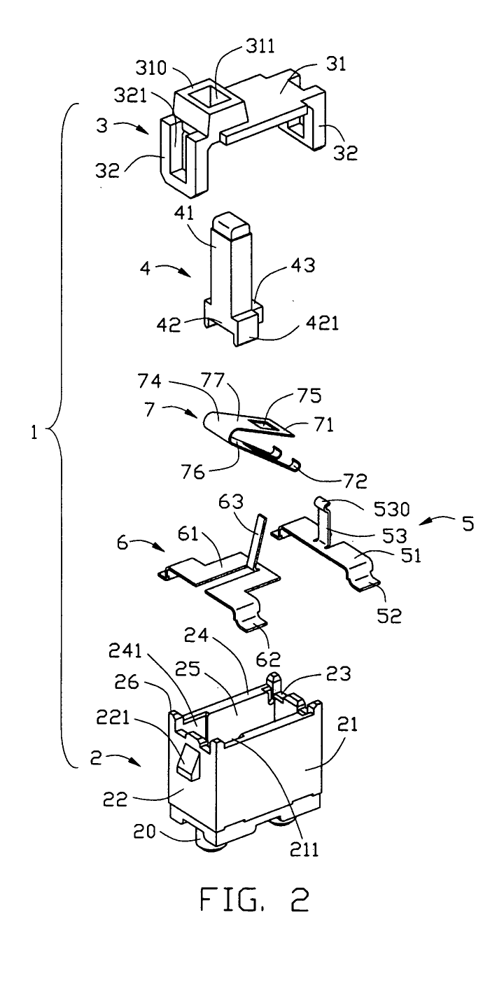

Referring to FIG. 2, a push button switch 1 according to this invention comprises a housing 2, a cover 3, an actuator 4, a common contacting contact 5, a non-common contacting contact 6 and a movable contact 7.

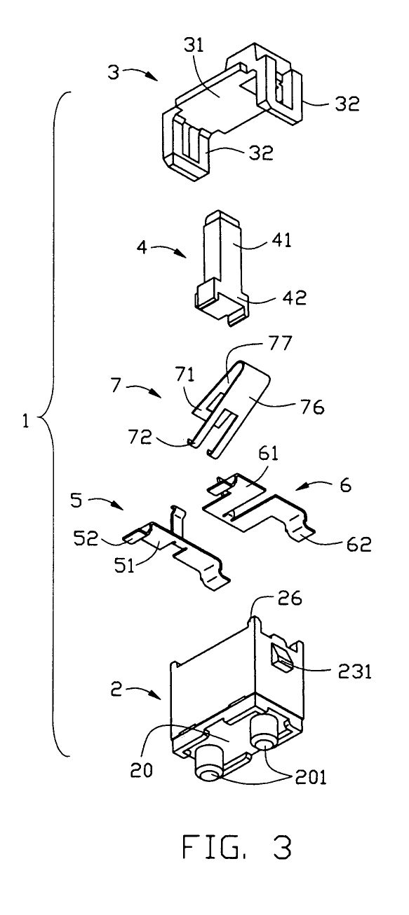

Referring FIGS. 2 and 3, the housing 2 is formed by molding an insulative material such as synthetic resin in a shape of substantially cubic. The housing 2 has a base 20. A periphery wall extends from the base 20 and a cavity 25 is defined therein. The periphery wall has opposite front and rear walls 21 and 24 and opposite left and right walls 22 and 23. The base 20 has a pair of posts 201 symmetrically projecting downwardly from a lower surface thereof. The base 20 also has a plurality of lower standoffs (not labeled) projecting from four corner portions of the lower surface of the base 20. The opposite left and right walls 22 and 23 each have a projection 221 or 231 vertically projecting from the outer surface thereof. The opposite front and rear walls 21 and 24, each defines a guiding groove 211 or 241 in a left portion of inner surface thereof. The periphery wall has four upwardly projecting protrusions 26 extending upwardly at the four corner portions on the upper surface thereof.

The cover 3 has a planar base plate 31, a pair of U-shaped locking lugs 32 depending from the planar base plate 31 to lock with the projections 221 and 231. The locking lug 32 is narrower than the planar base plate 31. The planar base plate 31 also has an upwardly projecting guiding block 310 corresponding to the guiding grooves 241 and 211 on a left portion thereof. A guiding hole 311 is defined downwardly through the block 310 and the planar base plate 31 for guiding the movement of actuator 4.

The actuator 4 comprises an operating portion 41, a holding portion 42 and a pressing portion 43. The operating portion 41 is substantially a rectangular shaped rod. The operating portion 41 extends downwardly and has press portion 43 laterally projecting from a lower end. The pressing portion 43 is substantially a block. The operating portion 41 has a holding portion 42 extending from the lower end in the directions vertically to the pressing portion 43. The holding portion 42 has a pair of tabs 421 respectively extending downwardly from opposite side portions thereof.

The common contacting contact 5 made of conductive material comprises a common contacting contact mounting portion 51 and a common contacting strip 53. The common contacting strip 53 extends upwardly from the common contacting contact mounting portion 51. The common contacting contact mounting portion 51 has a pair of common contacting terminal pieces 52 oppositely extending therefrom. The common contacting strip 53 has an arch-shaped hook portion 530 formed at an upper end. The non-common contacting contact 6 comprises a non-common contacting strip 63 and a non-common contacting contact mounting portion 61. The non-common contacting contact mounting portion 61 has a pair of common contacting terminal pieces 62 oppositely extending therefrom. The non-common contacting strip 63 extends upwardly from the non-common contacting contact mounting portion 61.

The movable contact 7 has a V-shaped configuration and comprises a resilient supporting portion 76, a connecting portion 77 and a bent portion interconnecting the supporting portion 76 and the connecting portion 77. A pair of offsetting fingers are formed on the supporting portion 76 and each has a curved end to form a supporting foot 72. A substantially rectangular shaped hole 75 is defined in the connecting portion 77 and is located adjacent to a right distal end of the connecting portion 77. A periphery section 71 surrounds the hole 75. A pressable section 74 is defined on the bent portion of the V-shaped movable contact 7.

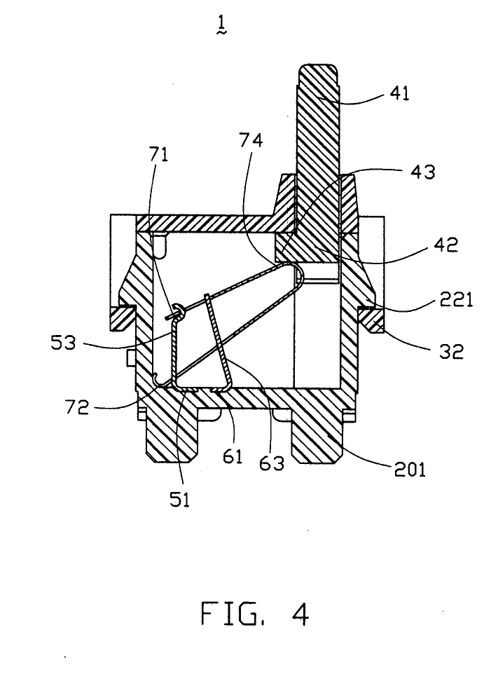

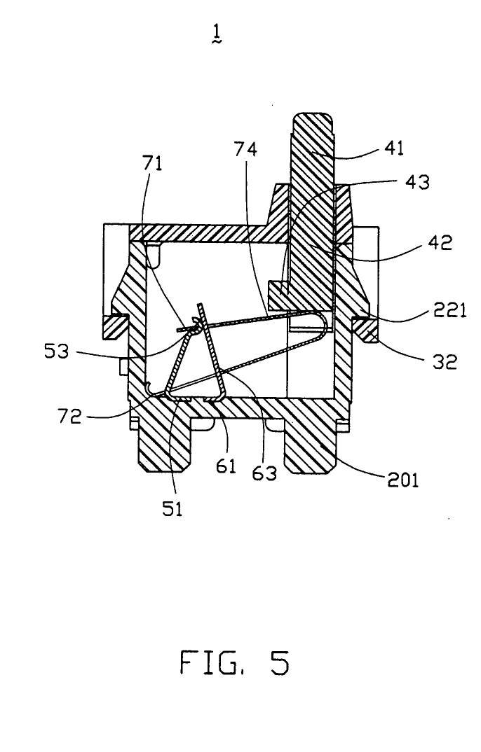

In assembly, the common contacting contact 5 and the non-common contacting contact 6 are retained in the housing 2 by insert molding. The common contacting terminal piece 52 and the non-common contacting terminal piece 62 extend out from the housing 2. The movable contact 7 is received in the cavity 25. The supporting foot 72 abuts a lower corner portion of the right wall 23. The periphery section 71 couples with the hook portion 530 of the common contacting strip 53. The non-common contacting strip 63 is located between the offsetting fingers, and a top portion extending through the hole 75. The top portion of the non-common contacting strip 63 is proximate to the movable contact 7 but not contacting it (best shown in FIGS. 4 and 5). The holding portion 42 catches movable contact 7 between the tabs 421. The pressing portion 43 abuts on the pressable section 74. The operating portion 41 upwardly projects through the guiding hole 311. The cover 3 engages with the housing 2 and is retained between the protrusions 26. The catch lugs 32 engage with the projections 221 and 231.

In operation, when the actuator 4 is downwardly pressed, the actuator 4 moves along the guiding grooves 211 and 241 and the pressing portion 43 downwardly presses the pressable section 74 of the movable contact 7. Upon depression on the pressable section 74, the supporting portion 76 is elastically deformed and the movable contact 7 pivots around the supporting foot 72. The periphery section 71 moves rightwards. As a result, the hook portion 530 of the common contacting strip 53 is brought to electrically contact with the non-common contacting strip 63. Thereby, the electrical connection is established (best shown in FIG. 5). When released, the deformed common contacting strip 53 recovers and the movable contact 7 restores to the normal status.

In the present invention, the common contacting strip 53 is capable of being moved with the movable contact 7 to touch the non-common contacting strip 63, thereby establishing electrical connection with the non-common contacting strip 63. As a result, the switch avoids a sliding operation. Thus, it's no need for the switch to use lube and this structure can also prevent the dust to be gathered on the contacts.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A push button switch comprising:
an insulative housing;
a cover engaging with the housing and defining a guiding hole;
an actuator engaging with the guiding hole of the cover, partially projecting beyond the guiding hole and being movable in an actuating direction;
a movable contact received in the housing and comprising a connecting portion, a supporting portion, and a pressable section connecting the supporting portion and the connecting portion and being pressable by the actuator;
a non-common contacting contact mounted in the housing and having a non-common contacting strip; and
a common contacting contact mounted in the housing, comprising a common contacting strip, engaging with the connecting portion of the movable contact and be movable with the movable contact to touch the non-common contacting strip, thereby electrically connecting with the non-common contacting contact.

2. A push button switch as claimed in claim 1, wherein the actuator comprises an operating portion extending out the guiding hole.

3. A push button switch as claimed in claim 1, wherein the movable contact has a hole defined in the connecting portion, a periphery section surrounds the hole, and the common contacting contact forms a hook portion extending through the hole and engaging with the periphery section.

4. A push button switch as claimed in claim 3, wherein the movable contact has a pair of offsetting fingers formed on the supporting portion, the common contacting strip projecting upwardly and being located between the offsetting fingers.

5. A push button switch as claimed in claim 3, wherein the non-common contacting strip projects upwardly between the offsetting fingers and extends through the hole.

6. A push button switch comprising:
an insulative housing;
first and second conductive contacts disposed in the housing with respective tails for respectively connecting to exterior electronic components, said first contact defining a resilient arm spaced from the second contact;
an actuator moveably positioned on the housing; and
a moveable contact disposed in the housing and actuated to be moved by said actuator so as to move the resilient arm to mechanically and electrically contact the second contact.

7. The push button switch as claimed in claim 6, wherein said actuator is linearly moveable relative to the housing.

8. The push button switch as claimed in claim 6, wherein said moveable contact is generally rotated during movement.

9. The push button switch as claimed in claim 8, wherein said moveable contact defines a V-shaped configuration with one end abutting against one corner of the housing.

10. A push button switch comprising:
an insulative housing;
first and second conductive contacts disposed in the housing with respective tails for respectively connecting to exterior electronic components, at least one of said first contact and said second contact defining a resilient arm spaced from the other;
an actuator moveably positioned on the housing; and
a moveable contact disposed in the housing and actuated to be moved by said actuator so as to move the resilient arm to mechanically and electrically contact the other.

11. The push button switch as claimed in claim 10, wherein said actuator is linearly moveable relative to the housing.

12. The push button switch as claimed in claim 10, wherein said moveable contact is generally rotated during movement.

13. The push button switch as claimed in claim 10, wherein said moveable contact defines a V-shaped configuration with one end abutting against one corner of the housing.

14. The push button switch as claimed in claim 10, wherein the other defines another arm for electrically and mechanically contacting the resilient arm when said resilient arm is deflected, and said moveable contact includes a supporting portion defining a recess allowing said resilient arm and said arm to extend therethrough.

15. The push button switch as claimed in claim 10, wherein the other defines another arm for contacting the resilient arm when said resilient arm is deflected, and said moveable contact includes a connection portion with therein an opening allowing said resilient arm and said arm to extend therethrough.

16. The push button switch as claimed in claim 10, wherein the other defines another arm for contacting the resilient arm when said resilient arm is deflected, and said arm is not moved when said resilient arm is moved to said arm.
